(19) United States
(12) Patent Application Publication
(10) Pub. No.: US 2014/0282224 A1
(43) Pub. Date: Sep. 18, 2014

(54) DETECTION OF A SCROLLING GESTURE

(71) Applicant: QUALCOMM INCORPORATED, San Diego, CA (US)

(72) Inventor: Christopher Pedley, Cambridge (GB)

(73) Assignee: QUALCOMM INCORPORATED, San Diego, CA (US)

(21) Appl. No.: 13/844,087

(22) Filed: Mar. 15, 2013

(51) Int. Cl. G06F 3/0485

(52) U.S. Cl. CPC G06F 3/0485
USPC 715/784

(57) ABSTRACT

Methods, systems, computer-readable media, and apparatuses for implementation of a scrolling gesture are disclosed. In some embodiments, a control object is detected by a detection device, and movement of content on a display is matched to movement of the control object. In further embodiments, a speed of the control object is detected, and a free scrolling mode is entered when the speed exceeds a speed threshold.

### BACKGROUND

Aspects of the disclosure relate to display interfaces. In particular, a contactless interface and associated systems and methods are described that control content in a display using a gesture.

Standard interfaces for display devices typically involve physical manipulation of an electronic input. A television remote control involves pushing a button. A touch screen display interface involves detecting the touch interaction with the physical surface. Such interfaces have numerous drawbacks. As an alternative, a person's movements may be used to control electronic devices. A hand movement or movement of another part of the person's body can be detected by an electronic device and used to determine a command to be executed by the device (e.g., provided to an interface being executed by the device) or to be output to an external device. Such movements by a person may be referred to as a gesture. Gestures may not require the person to physically manipulate an input device.

### BRIEF SUMMARY

Various potential embodiments of an interface and associated systems and methods are described that control content in a display using a scrolling gesture. While particular potential implementations according to certain embodiments are described, it is to be understood that additional embodiments not specifically detailed are possible in accordance with the description and claims.

One potential embodiment may be a method comprising: engaging, in response to a scroll initiating input from a user, a scrolling process; detecting, based on information from one or more remote detection devices, a speed of a control object associated with the user during the scrolling process; and executing at a computerized device one of a plurality of scroll modes during the scrolling process based on the detected speed.

Another embodiment of such a method may further function where the executing comprises: matching, as part of the scrolling process, a first content movement on a display to a first scrolling movement of the control object when the speed of the control object during the first scrolling movement of the control object is below a speed threshold; and engaging a free scrolling mode when the speed of the control object is above the speed threshold as part of a second scrolling movement of the control object.

Another embodiment of such a method may further function where the control object comprises a fingertip of the user, and wherein engaging the free scrolling mode when the speed of the control object is above the speed threshold as part of the second scrolling movement of the hand comprises: detecting a flicking motion of the fingertip where the speed of the fingertip exceeds the speed threshold while a speed of a hand associated with the fingertip does not exceed the speed threshold.

Another embodiment of such a method may further function where the scrolling mode comprises pausing matching the first content movement to the first scrolling movement of the control object when the control object moves away from the plane parallel to the display surface at a first area and resuming matching the first content movement to the first scrolling movement of the control object movement when the control object reenters the plane parallel to the display at a second area.

Another embodiment of such a method may further function where detecting that the control object is held in the still position for the predetermined time comprises: measuring, using the remote detection device, a z-axis distance from the display surface to the control object; wherein the plane parallel to the display surface is at the z-axis distance from the display surface plus or minus an error tolerance distance in the z-axis direction; and identifying the plane parallel to the display surface based on the z-axis distance from the display surface to the control object.

Another embodiment of such a method may further function where a user selection of a scrolling mode from one of the plurality of scroll modes while the control object is in the plane parallel to the display surface. Another embodiment of such a method may further comprise setting a content scroll speed to a maximum scroll speed in response to the second scrolling movement of the control object; and decelerating the content scroll speed at a predetermined rate. Another embodiment of such a method may further comprise detecting a poking motion normal to a plane parallel to the display surface; and setting the content scroll speed to zero in response to the poking motion.

Another embodiment of such a method may further function where detecting that the control object is held in the predetermined pose comprises detecting that the control object remains within a cubic area for the threshold amount of time. Another embodiment of such a method may further function where the initiating input of the control object comprises detecting that the control object is held in a predetermined pose for a threshold amount of time. Another embodiment of such a method may further function where detecting the speed of the control object comprises detecting a control object acceleration between a first frame and a second frame; and rejecting the speed of the control object associated with the first frame and the second frame as a jitter error if the control object acceleration is above a predetermined acceleration threshold. Another embodiment of such a method may further function where detecting the speed of the control object comprising detecting an average speed of the control object over at least a minimum allowable free scrolling distance.

Another embodiment of such a method may further function where detecting the speed of the control object comprises receiving accelerometer data from a device held by the user. Another embodiment of such a method may further function where the scrolling process comprises a sideways motion of content in a display. Another embodiment of such a method may further function where the executing comprises causing content to scroll according to the one mode at a display of a head mounted display, wherein the content scrolls on a virtual display surface projected onto an eye of the user by the head mounted display.

Another embodiment may be a system comprising: a first camera; a first computing device communicatively coupled to the first camera; and an output display communicatively coupled to the first computing device and communicatively coupled to the first camera; wherein the first computing device comprises a gesture analysis module configured to: engage, in response to a scroll initiating input from a user, a scrolling process; detect, based on information from one or more remote detection devices, a speed of a control object associated with the user during the scrolling process; and execute at a computerized device one of a plurality of scroll modes during the scrolling process based on the detected speed.

Another embodiment of such a system may further function where the gesture analysis module further matches, as part of a first scroll mode of the plurality of scroll modes, a first content movement in a display on a display surface to a first scrolling movement of the control object when the speed of the control object during the first scrolling movement of the control object is below a speed threshold.

Another embodiment of such a system may further function where the first scroll mode comprises pausing matching the first content movement to the first scrolling movement of the control object when the control object moves away from the plane parallel to the display surface at a first area and resuming matching the first content movement to the first scrolling movement of the control object movement when the control object reenters the plane parallel to the display at a second area.

Another embodiment of such a system may further function where the gesture analysis module engages a free scrolling mode as a second scroll mode of the plurality of scroll modes when the speed of the control object is above the speed threshold.

Another embodiment of such a system may further comprise a second camera communicatively coupled to the first computing device and the output display; wherein the gesture analysis module identifies an obstruction between the first camera and the control object and detects the movement of the control object using a second image from the second camera.

Another embodiment may be a device comprising: means for engaging, in response to a scroll initiating input from a user, a scrolling process; means for detecting, based on information from one or more remote detection devices, a speed of a control object associated with the user during the scrolling process; and means for executing at a computerized device one of a plurality of scroll modes during the scrolling process based on the detected speed.

Another embodiment of such a device may further comprise means for matching, as part of the scrolling process, a first content movement on a display to a first scrolling movement of the control object when the speed of the control object during the first scrolling movement of the control object is below a speed threshold; and means for engaging a free scrolling mode when the speed of the control object is above the speed threshold as part of a second scrolling movement of the control object.

Another embodiment of such a device may further comprise means for matching the first content movement to the first scrolling movement of the control object when the control object moves away from the plane parallel to the display surface at a first area and resuming matching the first content movement to the first scrolling movement of the control object movement when the control object reenters the plane parallel to the display at a second area; means for measuring, using the remote detection device, a z-axis distance from the display surface to the control object; wherein the plane parallel to the display surface is at the z-axis distance from the display surface plus or minus an error tolerance distance in the z-axis direction; and means for identifying the plane parallel to the display surface based on the z-axis distance from the display surface to the control object.

Another embodiment of such a device may further function where a user selection of a scrolling mode from one of the plurality of scroll modes is made while the control object is in the plane parallel to the display surface. Another embodiment of such a device may further comprise means for setting a content scroll speed to a maximum scroll speed in response to the second scrolling movement of the control object; and means for decelerating the content scroll speed at a predetermined rate.

Another embodiment of such a device may further comprise means for detecting a poking motion normal to a plane parallel to the display surface; and means for setting the content scroll speed to zero in response to the poking motion.

Another embodiment of such a device may further comprise means for detecting that the control object remains within a cubic area for the threshold amount of time. Another embodiment of such a device may further comprise means for detecting that the control object is held in a predetermined pose for a threshold amount of time. Another embodiment of such a device may further comprise means for detecting a control object acceleration between a first frame and a second frame; and means for rejecting the speed of the control object associated with the first frame and the second frame as a jitter error if the control object acceleration is above a predetermined acceleration threshold. Another embodiment of such a device may further comprise means for detecting an average speed of the control object over at least a minimum allowable free scrolling distance. Another embodiment of such a device may further comprise means for receiving accelerometer data from a device held by the user.

Another embodiment of such a device may further comprise means for a sideways motion of content in a display. Another embodiment of such a device may further comprise means for causing content to scroll according to the one mode at a display of a head mounted display, wherein the content scrolls on a virtual display surface projected onto an eye of the user by the head mounted display.

Another embodiment may be a non-transitory computer readable medium comprising computer readable instructions that when executed by a processor, cause a device to: engage, in response to a scroll initiating input from a user, a scrolling process; detect, based on information from one or more remote detection devices, a speed of a control object associated with the user during the scrolling process; and execute at a computerized device one of a plurality of scroll modes during the scrolling process based on the detected speed.

Additional embodiments of such a non-transitory computer readable medium may function where the instructions further cause the device to: match, as part of the scrolling process, a first content movement on a display to a first scrolling movement of the control object when the speed of the control object during the first scrolling movement of the control object is below a speed threshold; and engage a free scrolling mode when the speed of the control object is above the speed threshold as part of a second scrolling movement of the control object.

Additional embodiments of such a non-transitory computer readable medium may function where the instructions further cause the device to: setting a content scroll speed to a maximum scroll speed in response to the second scrolling movement of the control object; and decelerating the content scroll speed at a predetermined rate.

Additional embodiments of such a non-transitory computer readable medium may function where the instructions further cause the device to detect that the control object is held in a predetermined pose for a threshold amount of time as at least a portion of the initiating input.

Additional embodiments of such a non-transitory computer readable medium may function where detecting the speed of the control object comprises detecting a control object acceleration between a first frame and a second frame; and the instructions further cause the device to reject the speed of the control object associated with the first frame and the second frame as a jitter error if the control object acceleration is above a predetermined acceleration threshold.

One potential method according to a potential embodiment involves remotely detecting, using a remote detection device, a control object associated with a user; engaging, in response to a scroll initiating input, a scrolling mode; remotely detecting, using the remote detection device, a speed of the control object; matching, as part of the scrolling mode, a first content movement in a display on a display surface to a first scrolling movement of the control object when the speed of the control object during the first scrolling movement of the control object is below a speed threshold; and engaging a free scrolling mode when the speed of the control object is above the speed threshold as part of a second scrolling movement of the control object.

In a further embodiment according to such a method, the first scrolling movement of the control object is in a plane parallel to the display surface and where the second scrolling movement of the control object is in the plane parallel to the display surface.

In an additional further embodiment according to such a method the scrolling mode comprises pausing matching the first content movement to the first scrolling movement of the control object when the control object moves away from the plane parallel to the display surface at a first area and resuming matching the first content movement to the first scrolling movement of the control object movement when the control object reenters the plane parallel to the display at a second area.

In an additional further embodiment according to such a method the initiating motion of the control object comprises detecting that the control object is held in a still position for a predetermined time. In an additional further embodiment according to such a method detecting that the control object is held in the still position for the predetermined time comprises: measuring, using the remote detection device, a z-axis distance from the display surface to the control object; where the plane parallel to the display surface is at the z-axis distance from the display surface plus or minus an error tolerance distance in the z-axis direction.

In an additional further embodiment according to such a method detecting that the control object is held in a still position comprises detecting that the control object remains within a 10 mm cube area for a minimum of 300 ms. In an additional further embodiment according to such a method, the method additionally involves setting a content scroll speed to a maximum scroll speed in response to the second scrolling movement of the control object; and decelerating the content scroll speed at a predetermined rate.

In an additional further embodiment according to such a method, the method additionally involves detecting a poking motion normal to a plane parallel to the display surface; and setting the content scroll speed to zero in response to the poking motion. In an additional further embodiment according to such a method detecting the speed of the control object comprises detecting a control object acceleration between a first frame and a second frame; and rejecting the speed of the control object associated with the first frame and the second frame as a jitter error if the control object acceleration is above a predetermined acceleration threshold.

In an additional further embodiment according to such a method detecting the speed of the control object comprising detecting an average speed of the control object over at least a minimum allowable free scrolling distance. In still further potential embodiment the control object may be a hand of the user, the control object may be a fingertip of the user, or the control object may be an electronic device held in a hand of the user.

In an additional further embodiment according to such a method engaging the free scrolling mode when the speed of the control object is above the speed threshold as part of the second scrolling movement of the hand comprises: detecting a flicking motion of the fingertip where the speed of the fingertip exceeds the speed threshold while a speed of a hand associated with the fingertip does not exceed the speed threshold.

In an additional further embodiment according to such a method the display surface is roughly or approximately parallel to a ground surface. In an additional further embodiment according to such a method the display surface is perpendicular to a ground surface and where the first content movement may be limited to a movement along a horizontal vector that may be in a plane perpendicular to the ground surface. In an additional further embodiment according to such a method the display comprises a head mounted display and where the display surface may be a virtual display surface projected onto an eye of the user by the head mounted display.

Another potential embodiment consists of an apparatus, where the apparatus includes a processing module comprising a computer processor. The apparatus may further include a computer readable storage medium coupled to the processing module; a display output module coupled to the processing module; and an image capture module coupled to the processing module. Additionally, as part of the apparatus, the computer readable storage medium comprises computer readable instructions that, when executed by the computer processor, cause the computer processor to perform a method comprising: detecting a control object associated with a user; engaging, in response to a scroll initiating input, a scrolling mode; detecting a speed of the control object; matching, as part of the scrolling mode, a first content movement in a display on a display surface to a first scrolling movement of the control object when the speed of the control object during the first scrolling movement of the control object is below a speed threshold; and engaging a free scrolling mode when the speed of the control object is above the speed threshold as part of a second scrolling movement of the control object.

In an additional further embodiment according to such an apparatus, the apparatus further includes an audio sensor and a speaker, where the scroll initiating input comprises a voice command received via the audio sensor. In an additional further embodiment according to such an apparatus, the apparatus further includes an antenna, cellular telephone communication module, and a local area network module. In such an apparatus, the content may be communicated to a display from the display output module via the local area network module; and the image capture module may be coupled to the processor via the local area network module.

Another potential embodiment consists of a system, where the system includes a first camera; a first computing device communicatively coupled to the first camera; and an output display communicatively coupled to the first computing device. In such a system, the first computing device may include gesture analysis module that: identifies a control object associated with a user using an image from the first camera, engages, in response to a scroll initiating input, a scrolling mode; detects, using the first camera, a speed of the control object; matches, as part of the scrolling mode, a first content movement in a display on a display surface to a first scrolling movement of the control object when the speed of the control object during the first scrolling movement of the control object is below a speed threshold; and engages a free scrolling mode when the speed of the control object is above the speed threshold as part of a second scrolling movement of the control object.

A further potential embodiment of such a system may also include a second camera communicatively coupled to the first computing device, where the gesture analysis module identifies an obstruction between the first camera and the control object and detects the movement of the control object using a second image from the second camera. A further embodiment of such a system may additionally function where the gesture analysis module is further configured to engage a free scrolling mode when the speed of the control object is above the speed threshold as part of a second scrolling movement of the control object.

A further embodiment of such a system may additionally comprise setting a content scroll speed to a maximum scroll speed in response to the second scrolling movement of the control object; and decelerating the content scroll speed at a predetermined rate.

A further embodiment of such a system may additionally comprise detecting a stop hand signal in a plane parallel to the display surface of the display; and setting the content scroll speed to zero in response to the stop hand signal.

A further embodiment of such a system may additionally comprise detecting a pointing gesture in a plane parallel to the display surface of the display; and setting the content scroll speed to zero in response to the pointing gesture; and matching a second content movement to a second scrolling movement of the control object following detection of the pointing gesture.

A further embodiment of such a system may additionally function where the scroll initiating input from the user comprises detecting that the control object is held in a predetermined pose for a threshold amount of time;

A further embodiment of such a system may additionally function where detecting that the control object is held in the predetermined pose for the threshold amount of time comprises: measuring, using the one or more remote detection devices, a z-axis distance from a display surface to the control object, wherein a plane parallel to the display surface is at the z-axis distance from the display surface plus or minus an error tolerance distance in a z-axis direction; and identifying the plane parallel to the display surface based on the z-axis distance from the display surface to the control object. A further embodiment of such a system may additionally function where detecting the speed of the control object comprises detecting a control object acceleration between a first frame and a second frame; and rejecting the speed of the control object associated with the first frame and the second frame as a jitter error if the control object acceleration is above a predetermined acceleration threshold. A further embodiment of such a system may additionally function where the scrolling process comprises a diagonal motion of content in a display.

An additional embodiment may be a method, comprising: detecting a motion of a control object at a first device; executing, at the device, at least one of a plurality of commands corresponding to the detected motion based on a velocity of the control object. Additional embodiments according to such a method may further comprise determining the velocity prior to the executing at least one of the plurality of command.

In additional embodiments according to such a method, at least two of the plurality of commands corresponding to the detected motion comprise different modes of a single instruction. In additional embodiments according to such a method, at least two of the plurality of commands corresponding to the detected motion comprise different instructions. In additional embodiments according to such a method, the control object comprises a hand of a user of the device. In additional embodiments according to such a method, the control object is detected based on images captured by a camera associated with the device. In additional embodiments according to such a method, the control object is detected based on information received from a microphone detecting ultrasonic frequencies.

While various specific embodiments are described, a person of ordinary skill in the art will understand that elements, steps, and components of the various embodiments may be arranged in alternative structures while remaining within the scope of the description. Also, additional embodiments will be apparent given the description herein, and thus the description is not referring only to the specifically described embodiments, but to any embodiment capable of the function or structure described herein.

### BRIEF DESCRIPTION OF THE DRAWINGS

Aspects of the disclosure are illustrated by way of example. In the accompanying figures, like reference numbers indicate similar elements, and:

FIG. 1A illustrates an environment including a system that may incorporate one or more embodiments;

FIG. 1B illustrates an environment including a system that may incorporate one or more embodiments;

FIG. 2A illustrates an environment that may incorporate one or more embodiments;

FIG. 2B illustrates an aspect of a gesture that may be detected in one or more embodiments;

FIG. 2C illustrates an aspect of a gesture that may be detected in one or more embodiments;

FIG. 2D illustrates an aspect of a gesture that may be detected in one or more embodiments;

FIG. 2E illustrates an aspect of a gesture that may be detected in one or more embodiments;

FIG. 2F illustrates an aspect of a gesture that may be detected in one or more embodiments;

FIG. 2G illustrates an aspect of a gesture that may be detected in one or more embodiments;

FIG. 2H illustrates an aspect of a gesture that may be detected in one or more embodiments;

FIG. 2I illustrates an aspect of a gesture that may be detected in one or more embodiments;

FIG. 2J illustrates an aspect of a gesture that may be detected in one or more embodiments;

FIG. 3A illustrates one aspect of a method that may incorporate one or more embodiments;

FIG. 3B illustrates one aspect of a method that may incorporate one or more embodiments;

FIG. 3C illustrates one aspect of a method that may incorporate one or more embodiments;

FIG. 4 illustrates one aspect of a system that may incorporate one or more embodiments;

FIG. 5A illustrates one aspect of a system including a head mounted device that may incorporate one or more embodiments;

FIG. 5B illustrates one aspect of a system that may incorporate one or more embodiments; and

FIG. 6 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Some embodiments are directed to display interfaces. In certain embodiments, contactless interfaces and an associated method for control of content in a display using a contactless interface are described. As the input devices and computing power available to users continues to increase, using gestures and in particular free-air gestures to interact with content surfaces is desirable in some situations. One potential navigation interaction involves navigating around large content items using a free-air scrolling gesture which may be made relative to a content surface, such as a liquid crystal or plasma display surface. A content surface may also be an arbitrary surface onto which an image is projected by a projector, or upon which an image appears to be projected using, for example, glasses that transmit an image to the user's eyes showing an image that appears to be upon the arbitrary surface, such as may be implemented in a head mounted display (HMD). Detection of the gesture is not based on any detection at the surface, but is instead based on detection of a control object such as the user's hands by a detection device, as detailed further below. “Remote” and “contactless” gesture detection thus refers herein to the use of sensing devices to detect gestures remote from the display, as contrasted to devices where contact at the surface of a display is used to input commands to control content in a display. In some embodiments, a gesture may be detected by a handheld device, such as a controller or apparatus comprising an inertial measurement unit (IMU). Thus, a device used to detect a gesture may not be remote with respect to the user, but such device and/or gesture may be remote with respect to the display interfaces

In one example embodiment, a wall mounted display is coupled to a computer, which is in turn further coupled to a camera. When a user interacts with the display from a location that is in view of the camera, the camera communicates images of the user to the computer. The computer recognizes gestures made by the user, and adjusts the presentation of content shown at the display in response to gestures of the user. A particular scrolling gesture may be used, for example. In one implementation of the scrolling gesture, the user extends a hand or finger toward the display surface as a control object. The user then moves his or her hand to control scrolling of content on the display. In some embodiments, when the user's hand passes a speed threshold, the content will free-scroll in a predetermined fashion until the user inputs a command to stop the scrolling or the scrolling decelerates to a stop on its own. When movement of the user's hand is below, the speed threshold, movement of the content may be matched to the movement of the hand. The camera captures images of the user's hand gesture, and communicates the images to the computer, where they are processed to create the content scrolling. Additional details are described below.

As used herein, the terms “computer,” “personal computer” and “computing device” refer to any programmable computer system that is known or that will be developed in the future. In certain embodiments a computer will be coupled to a network such as described herein. A computer system may be configured with processor-executable software instructions to perform the processes described herein. FIG. 6 provides additional details of a computer as described below.

As used herein, the term “component,” “module,” and “system,” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

As used herein, the term “gesture” refers to a movement through space over time made by a user. The movement may be made by any control object under the direction of the user.

As used herein, the term “control object” may refer to any portion of the user's body, such as the hand, arm, elbow, or foot. The gesture may further include a control object that is not part of the user's body, such as a pen, a baton, or an electronic device, for example with an output that makes movements of the device more readily visible to the camera and/or more easily processed by a computer coupled to the camera or including an accelerometer or inertial measurement unit (IMU) to detect motions of the device. Embodiments may use more than one control object, and in such embodiments, the two or more control objects need not be identical. For example, one control object may be an electronic device, and a second control object may be a hand of the user.

As used herein, the term “remote detection device” refers to any device capable of capturing data associated with and capable of being used to identify a gesture. In one embodiment, a video camera is an example of a remote detection device which is capable of conveying the image to a processor for processing and analysis to identify specific gestures being made by a user. A remote detection device such as a camera may be integrated with a display, a wearable device, a phone, or any other such camera presentation. The camera may additionally comprise multiple inputs, such as for a stereoscopic camera, or may further comprise multiple units to observe a greater set of user locations, or to observe a user when one or more camera modules are blocked from viewing all or part of a user. A remote detection device may detect a gesture using any set of wavelength detection. For example, a camera may include an infrared light source and detect images in a corresponding infrared range. In further embodiments, a remote detection device may comprise sensors other than a camera, such as inertial sensors that may track movement of a control device using an accelerometer, gyroscope or other such elements of a control device. Further remote detection devices may include ultraviolet sources and sensors, acoustic or ultrasound sources and sound reflection sensors, MEMS-based sensors, any electromagnetic radiation sensor, or any other such device capable of detecting movement and/or positioning of a control object.

As used herein, the term “display” and “content surface” refer to an image source of data being viewed by a user. Examples include liquid crystal televisions, cathode ray tube displays, plasma display, and any other such image source. In certain embodiments, the image may be projected to a user eye rather than presented from a display screen. In such embodiments, the system may present the content to the user as if the content was originating from a surface, even though the surface is not emitting or reflecting the light. One example is a pair of glasses as part of a head mounted device that provides images to a user.

As used herein, the term “head mounted device” (HMD) or “body mounted device” (BMD) refers to any device that is mounted to a user's head, body, or clothing or otherwise worn or supported by the user. For example, an HMD or a BMD may comprise a device that captures image data and is linked to a processor or computer. In certain embodiments, the processor is integrated with the device, and in other embodiments, the processor may be remote from the HMD. In an embodiment, the head mounted device may be an accessory for a mobile device CPU (e.g., the processor of a cell phone, tablet computer, smartphone, etc.) with the main processing of the head mounted devices control system being performed on the processor of mobile device. In another embodiment, the head mounted device may comprise a processor, a memory, a display and a camera. In an embodiment, a head mounted device may be a mobile device (e.g., smartphone, etc.) that includes one or more sensors (e.g., a depth sensor, camera, etc.) for scanning or collecting information from an environment (e.g., room, etc.) and circuitry for transmitting the collected information to another device (e.g., server, second mobile device, etc.). An HMD or BMD may thus capture gesture information from a user and use that information as part of a contactless control interface.

In another embodiment, the head mounted device may include a wireless interface for connecting with the Internet, a local wireless network, or another computing device. In another embodiment, a pico-projector may be associated in the head mounted device to enable projection of images onto surfaces. The head mounted device may be lightweight and constructed to avoid use of heavy components, which could cause the device to be uncomfortable to wear. The head mounted device may also be operable to receive audio/gestural inputs from a user. Such gestural or audio inputs may be spoken voice commands or a recognized user gesture, which when recognized by a computing device may cause that device to execute a corresponding command.

As used herein, “content” refers to a file or data which may be presented in a display, and manipulated with a scrolling gesture. Examples may be text files, pictures, or movies which may be stored in any format and presented to a user by a display. During presentation of content on a display, details of content may be associated with the particular display instance of the content, such as color, zoom, detail levels, and a current content position.

As used herein, “content area” refers to a portion of content that may or may not be present on a display at any given time in a particular content position. Such a position may be associated with spatial coordinates on a display or within a total area of a visual content that may be presented on a display surface. The content position may further refer to a characteristic of content that may be presented on a display. In particular, when content is zoomed such that the entire content is not visible on the display surface, a current content position may be used to match a gesture to a scrolling transformation presented at a content surface, and shift a portion of the content that is presented at the display surface as the current content position is updated. As part of such a transformation, a first content area may be shifted out of a display surface while a second content area may be shifted into a display surface.

FIGS. 1A and 1B illustrate two potential environments in which embodiments of a contactless scrolling gesture may be implemented. Both FIGS. 1A and 1B include a display 14 mounted on surface 16. Additionally, in both figures a hand of the user functions as control object 20. In FIG. 1A, HMD 10 is worn by a user 6. Mobile computing device 8 is attached to user 6. In FIG. 1A, HMD 10 is illustrated as having an integrated camera shown by shading associated with camera field of vision 12. The field of vision 12 for a camera embedded in HMD 10 is shown by the shading, and will move to match head movements of user 6. Camera field of vision 12 is sufficiently wide to include the control object 20 when it is placed in a control plane parallel to surface 16 and display 14.

Reference axis are shown in FIGS. 1A, 1B, and 2A with an x direction along the base of surface 16, a y direction that is up and down along the height of surface 16, and a z direction that is normal to the plane of surface 16. A control plane may be any roughly x-y plane between the user and display 14. In alternative embodiments, the plane may be offset from the plane of the display, especially if the user's body is offset from a position looking at the display. In further embodiments, the control plane may be at the surface of display 14 such that the control objects touch display 14, or the control plane may be in free space, offset from the surface of display 14 in the z direction.

In the system of FIG. 1A, the image from HMD 10 may be communicated wirelessly from a communication module within HMD 10 to a computer associated with display 14, or may be communicated from HMD 10 to mobile computing device 8 either wirelessly or using a wired connection. In an embodiment where images are communicated from HMD 10 to mobile computing device 8, mobile computing device 8 may communicate the images to an additional computing device that is coupled to the display 14. Alternatively, mobile computing device 8 may process the images to identify a gesture, and then adjust content being presented on display 14, especially if the content on display 14 is originating from mobile computing device 8. In a further embodiment, mobile computing device 8 may have a module or application that performs an intermediate processing or communication step to interface with an additional computer, and may communicate data to the computer which then adjusts the content on display 14.

In certain embodiments, display 14 may be a virtual display created by HMD 10. In one potential implementation of such an embodiment, HMD may project an image into the user's eyes to create the illusion that display 14 is projected onto a surface when the image is actually simple projected from the HMD to the user. The display may thus be a virtual image represented to a user on a passive surface as if the surface were an active surface that was presenting the image. If multiple HMD are networked or operating using the same system, then two or more users may have the same virtual display with the same content displayed at the same time. A first user may then manipulate the content in a virtual display and have the content adjusted in the virtual display as presented two both users. Such virtual objects are described in more detail with respect to the embodiment of HMD 10 shown by FIG. 5.

FIG. 1B illustrates an alternative embodiment, wherein the image detection is performed by camera 18, which is mounted in surface 16 along with display 14. In such an embodiment, camera 18 will be communicatively coupled to a processor that may be part of camera 18, part of display 14, or part of a computer system communicatively coupled to both camera 18 and display 14. Camera 18 has a field of view 19 shown by the shaded area, which will cover control objects as they move through an x-y control plane. In certain embodiments, a camera may be mounted to an adjustable control that moves field of view 19 in response to detection of a height of user 6. In further embodiments, multiple cameras may be integrated into surface 16 to provide a field of vision over a greater area, and from additional angles in case user 6 is obscured by an obstruction blocking a field of view of camera 18. Multiple cameras may additionally be used to provide improved gesture data for improved accuracy in gesture recognition. In further embodiments, additional cameras may be located in any location relative to the user to provide gesture images.

FIG. 2A shows a reference illustration of a coordinate system that may be applied to an environment in an embodiment. In the embodiments of FIGS. 1A and 1B, the x-y arrows of FIG. 2A may correspond with the x-y plane of FIGS. 1A and 1B. User 210 is shown positioned in a positive z-axis location facing the x-y plane, and user 210 may thus make a gesture that may be captured by a camera, with the user facing the display, with the coordinates of the motion captured by the camera processed by a computer using the corresponding x, y, and z coordinates as observed by the camera. In various potential embodiments of a scrolling gesture, the scrolling may be limited to a single axis, or may be allowable along multiple axes. For example if the content comprises a grid of pictures, and a display surface is set in an x-y plane, a scrolling gesture may be allowable along the x-axis to scroll across columns of pictures in the grid, and a scrolling gesture may be allowable along the y-axis to scroll along rows of pictures in the grid. In alternate embodiments, such as in a text document, only a single axis may be scrollable. In still further embodiments, such as when a user is interacting with a large picture image, a system may enable scrolling along combined axes or a diagonal by functioning with a diagonal control object movement that moves along a diagonal vector from a current object position to a new object position. For example, if a user is in the center of a large image, and wishes to view the bottom right portion of the image, the user may make a movement of the control object up and to the left to scroll the image diagonally.

A stream of frames containing x, y, and z coordinates of the user hands and optionally other joint locations may then be received to identify the gesture. Such information may be recorded within a coordinate system or framework identified by the gesture recognition system as shown in FIG. 2C. In one embodiment, to engage the scrolling operation, the user may hold the control object still and level, and once the system is engaged, scrolling begins to track the control object. The system may be designed with certain thresholds, such that a control object may be considered still if they remain within a roughly defined volume for a predetermined amount of time. The level position of the control object may be analyzed to determine that it remains within a 10 mm cube area for 300 ms to initiate a scrolling mode as a scroll initiating input. In additional embodiments, particular poses may be recognized by a system as consistent with a gesture command, and may be required to initiate a scrolling mode using a gesture. For example, in addition to staying still, a specific still pose such as a hand in an open palm position with fingers extended may be recognized as a scrolling gesture. Other poses in the same position may either have other associated modes. For example, an open palm with fingers together may be a selection mode or a marking mode. In still further embodiments, other poses may not have an associated command in order to minimize confusion as a system interprets a gesture. With any such gesture, an additional input other than a gesture command may be recognized in addition to the gesture, such as a voice command or a button on a remote or on an electronic control object.

FIG. 2B illustrates an embodiment of a scrolling gesture. FIG. 2B includes control object 220, camera 218, and display 214. Control object 220 is shown as a user's hands. Content area 250 is displayed on display 214. Positions 222a, 222b, 230a, and 230b are also shown.

FIG. 2B illustrates control object 220 moving from position 222A to position 222B when the speed of the control object 220 does not exceed a speed threshold. Camera 218 captures images of control object 220, and communicates the images to a gesture recognition module which controls content presented on display 214. A portion of content comprising content area 250 is then shifted from position 230a to position 230b in response to the gesture. As seen in FIG. 2B, movement of the content in the content area 250 may substantially match or corresponding to movement of the control object when the velocity of the control object does not exceed a certain threshold.

FIGS. 2C through 2J further illustrate a scrolling gesture. In FIG. 2C, control object 220 is shown at position 222A, and the content area 250 is shown at position 230a. In FIGS. 2D and 2E, the user moves his hand upward, and the content moves upward on the display. In FIG. 2F, the user retracts his hand away from the display. In certain embodiments, this may function to pause the scrolling action while the user repositions the control object. In FIG. 2G, the user repositions the control object to a lower position, and continues to scroll the content area 250 upwards in FIGS. 2H and 2I. In FIG. 2J, the control object is again retracted to pause the scrolling. Repetition of this scrolling and removal motion may be referred to as recycling, and enables matched scrolling in one direction beyond a single movement range of a user.

If, in any of FIGS. 2C-2E or 2G through 2I, the speed of control object 220 were to exceed the speed threshold, then content in area 250 may continue scrolling upwards even after movement of control object 220 stopped. In some embodiments, motion of the control object in FIGS. 2C-2E or 2G-2I may be substantially within a plane, and determining whether to enter such free scrolling mode may be performed while the control object is still in the plane.

In certain embodiments, the motion of the control object may be limited to a predefined control area. The control area may be, for example, a plane or volume parallel to a display surface. In other alternative embodiments, a gesture recognition system may identify a control area in real time as the gesture is made. For example in FIGS. 2C through 2E, the gesture recognition system may identify the sweep of control object 220 as a control vector or control arc, and match the movement of the content area 250 across the display to movement of control object 220. This control area may be fixed, or may be modified during operation of the gesture recognition system in response to movements or changes in stance by a user.

This control area or control vector may further be modified in response to observations of a particular user. For example, a default tolerance may be established to identify expected variations in a control gesture. However, certain movements such as shakes or jerking motions by a user may be identified, and tolerances on a control area, control vector, or control arc may be loosened to enable certain users to operate the system.

Similarly, speed thresholds and checks to insure that identified speeds are not due to jitter or shakiness may be included in embodiments. For example, a speed threshold may have an initial setting that may be adjusted in response to identified operation of a user. In one potential embodiment, a control object may be considered to be a fingertip of the user, and not the entire hand of the user. In such an embodiment, the speed of the hand may be low, but a flicking motion of the fingertip may cause the fingertip to exceed the speed threshold, and thus cause the system to enter a free scrolling mode. Additionally, certain flicking gestures may be identified, and if the gestures are repeated or presented at a speed below the speed threshold, the speed threshold for a particular user may be lowered, or a notification may be provided to the user that the system is having trouble recognizing the fingertip as a control object, and the entire hand may then be used as a control object in an automated control object switch performed by the system.

Further, the speed threshold may be controllable by a user, such that a user may use electronic, verbal, or gesture inputs to a system to adjust a speed threshold up or down. In one potential embodiment, successive frames for a system may be averaged, and the speed for the frames must exceed the threshold before a free scrolling action occurs. In another embodiment, the speed must be maintained over a distance to engage a free scrolling action. Such distances or number of frames may be fixed or adjusted based on a size of the control object, skeletal movement analysis of the user, or any other such analysis of a user's interaction with a gesture control system.

In still further embodiments, variations in the speed threshold may be based on additional factors. For example during extended scrolling sessions, a user may grow tired, and the speed threshold may be decreased over time to compensate for reduced control object speed as the user grows tired.

Additionally, in certain embodiments as mentioned above, once the control area or control vector is established, movement of the control object away from the area or vector may function to pause the scrolling of the content. Especially for large content, this may enable movement across the content without using the free scrolling mode by allowing a first movement, a pause while the control object is repositioned, and another movement. This may be repeated to allow scrolling matched to a control object across a large amount of content.

In embodiments where content scrolling is limited to, for example, the y-axis as in the example of FIG. 2, movement of the control object in an off axis direction may be ignored by the system, or may be compensated for such that the movement of the control object matches the y-axis movement of the content.

In embodiments where scrolling may occur on either the x-axis or the y-axis, or any other potential axis, the system may identify certain control object movement vectors with each axis, and scroll along the associated axis when an associated control object movement vector is identified. In other embodiments, certain vectors may be considered dead zones. For example, a control object movement vector at a 45 degree diagonal between the x and y axis may be ignored. For systems that enable diagonal scrolling, the diagonal scrolling may be limited to specific diagonal angles, such as only ever 15 degrees. In additional embodiments, a system may estimate an exact angle based on the control object movement, and enable scrolling along any potential diagonal vector.

In further embodiments, the relationship between the movement of control object 220 and the movement of content area 250 may be predefined or may be adjustable. In one potential example, a ratio of a distance from position 222a to 222b and a distance from 230a to 230b may be 1:1, 1:2, or any other potential ratio. A sound or other input control may be part of a gesture recognition system to change this ratio, such that a small motion of control object 220 may create a large movement of content area 250, or a large motion of control object 220 may create a small movement of content area 250. In further embodiments, a standard ratio such as 1:1 may be a default, or an initial default ratio may be calculated based on a size of the user or a distance of the user from the display.

While the figures presented show a display surface in a wall mounted type configuration, or where the display is along a vertical position, embodiments may also include table-top type display. In such embodiments, the user may remain upright in a standing or sitting position, but the control plane and content surface are now in an x-z plane according to the reference directions used in FIG. 2A. In such an embodiment, the gesture may be considered similar to touching a scroll and cloth with both hands, and sliding the scroll across the table. If the user makes a quick motion, the scrolling continues even after the user has retracted the control object, though the user may make a gesture to stop the scrolling. For slower movements, as the control object moves the content scrolls across the tabletop display in response to the synchronized movement of the control objects.

FIG. 3A describes one potential embodiment of a method for a scrolling gesture. While FIG. 3A describes one potential embodiment, additional embodiments may combine the elements of FIG. 3A with any element described below in FIGS. 3B and 3C, or in any embodiment described herein. As shown by FIG. 3, in 352, a scrolling process may be engaged in response to a scroll initiating input from a user, such as user 6 of FIG. 1 or user 210 of FIG. 2. The engagement process may be entirely within elements of an HMD 10, or may be part of a system 400 including a gesture analysis module 440 and a content control module 450 or any other such system. In 354, a speed of a control object associated with the user during the scrolling process is detected. Such an association may be done by a processing module 420 executing a gesture analysis module 440 to identify the speed, or may be done by any processor 610 of a computing device 600 within a system. This detection may be based on information from one or more remote detection devices such as HMD 10, camera 18, camera 218, or any other such detection device. In 356, one of a plurality of scroll modes is executed based on the detected speed. The scroll mode may be executed again using processing module 420 executing content control module 450 based on analysis performed by gesture analysis module 440 using images from image capture module 410. In alternative embodiments, similar functions may be carried out to perform 346 by elements of HMD 10 as shown by FIG. 5A, including any combination of scene sensor 500 and scene manager 510 using information from cameras 503.

FIG. 3B describes another potential method of implementing detection of a contactless scrolling gesture. In 311, a contactless control system with a remote detection device such as a video camera 503, HMD 10, or any other detection device described herein may be used to detect a control object. In 312, a system input may be received that functions as a scroll initiating input to start a scrolling mode. In certain embodiments, such an input may be detected before the control object may be detected. In some of such embodiments, the control object must be detected within a certain amount of time following the scroll initiating input, otherwise an additional scroll initiating input may be required.

In 314, the speed of the control object may be detected, and compared with a speed threshold. The detection may be done by the detection devices, with analysis done by a processing module such as gesture analysis module 440 operating on processing module 420, or scene manager 510. The speed threshold may be associated with a characteristic of the user, or may be a constant defined by the system as stored and retrieved from a memory of the system such as data store 555 or computer readable storage medium 430.

In 316, if the speed of the control object is below the speed threshold, movement of the content in a display is matched to movement of the control object. In 318, this match may be paused and resumed by movement of the control object away from and back into a control area in a recycling motion as described above. In some embodiments, the match may be paused automatically when the control object is positioned at a maximum reach of the user. In some embodiments, the match may be paused when a second control object is detected. For example, when the control object comprises a hand of the user, the match may be paused in some embodiments when the user holds up his other hand.

In 320, if the speed of the control object is above the speed threshold, a free scrolling mode may be engaged, scrolling the content across the display in a movement unconnected to subsequent motion of the control object. In 322, this free scroll mode may be terminated either by a set deceleration of the free scroll reducing the free scroll to a zero speed, or by a user input that ends the free scroll. In either case, the scroll speed of the content is set to zero. As described below, the user input to end the free scroll may comprise a “poke” gesture, a “stop” gesture, a voice command, an electronic control object selection of a button or other input, or any other user input associated with ending the free scroll. In another embodiment, a “point” gesture may terminate the free scroll and immediately inter a scroll matching mode that matches the movement of the point gesture.

In 324, the system returns to periodically check the control object speed to determine whether to proceed in a matched scroll or a free scroll in a loop back to 314. The loop is terminated in 326 when a scroll terminating input is received. This scroll terminating input may be removal of the control object from a control area, or may be any other type of system input to end the scroll mode. In certain embodiments, such a scroll terminating input may be received during a free scroll as well as during matched movement of the content to the control object. In other embodiments, a free scroll mode must be terminated independently before the system exits a scroll mode completely.

FIG. 3C, then, describes one additional embodiment of a method for implementing a contactless scrolling gesture. As part of the method of FIG. 3C, content such as a movie, a picture, or a text object is shown in a display such as display 14 of FIG. 1. A computing device controls which portions of the content are presented in which locations in a content surface. A remote detection device is coupled to the computer to observe gestures made by a user. After a start at 300, the following decision logic is followed to implement detection of a contactless panning gesture:

301. Check if a control object has been detected. If it has then proceed to 303, otherwise carry on looking for a control object at 302.

303. Check to see if an input has been received initiating a scroll mode. Such an input may be a verbal command, an electronic input, or may involve gesture detection. If such an input is detected, proceed to 304, otherwise return to 302 and continue searching for a control object.

304. Track changes in the detected control object position. If it moves up then move the content up, if it moves down then move the content down proportionally to the size of movement of the control object. Certain such embodiments may require the control object to be in an acceptable control area, where the match of control object movement with content movement only occurs when the control object is within or along the control area. For example, if a still hand is detected at a resting position, movement of the hand around the resting position may be ignored until the hand is brought into a control area, vector, or arc. As part of 304, a previously defined or adjusted control area associated with a particular control object may be identified from a memory store. If no previously defined control area is found, a new control area may be defined. In certain embodiments 304 then describes a tracking mode. During the tracking mode, the system constantly, periodically, or in response to a trigger, will check to see if an input has been received to pause or end the tracking mode. Two potential such checks are illustrated in 305 and 307.

305. During tracking and match of movement, check to see if the control object has been withdrawn from a control area or another input has been received terminating the scroll mode. If it has then proceed to 306. If not, return to 304. In 306, any adjustments to the control area associated with the specific detected control object are stored in memory, and tracking of the control object is terminated. The system then returns to 302 and proceeds to continue searching for a control object.

307. During 304 when the control object is moving within a control area, movement speed of the control object is checked. If the speed is below a speed threshold, the system continues in 304. If the speed is above a speed threshold, proceed to 308.

308. Allow the page to free scroll. The free scroll speed may be set by the detected speed of the control object, such that the initial scroll speed matches or is proportional to the detected maximum speed of the control object. Alternatively, the scroll speed may be set to a fixed maximum speed. The scroll speed may then be decelerated over time at a fixed or variable rate. During 308, 309 and 310 are checked.

309. Check for an input terminating the free scroll. One such input may be a sharp forward gesture of the hand in a control area, known as a poke. If such an input is detected, the system returns to 304. If not, the free scroll continues.

310. Check to see if the free scroll has decelerated to a minimum free scroll speed. If so, the system returns to 304. If not, the free scroll continues in 308.

The system may thus continue until system operation is terminated. As part of this system, the same control object may be detected multiple times in 301. This may enable the recycling motion described above in order to allow a single user to scroll in a matched mode across a large amount of content in the same direction. Alternatively, other users with different control objects may enter the system and be detected in 301. In certain embodiments, different users with different movement characteristics may use the same physical control object device, such as an electronic wand. The system may consider the use of the same control object by a different user to be a different control object, with a different control area stored in memory.

In one implementation of gesture detection, the control object may be defined as a volume or plane at a set z axis distance away from the display surface, where the z-axis is the line normal to the display surface in either a tabletop or wall mounted configuration. For such an embodiment, when detection is to be done to identify that a control object that has been detected has been held still, the system may further check that the control object is at a position along the z axis that is considered to be in the control area. If the system does not have a z-axis control position recorded, one may be created at a position of the control object.

As described above, in alternative embodiments, a sound or voice command may be used to initiate the scrolling mode. Alternatively a button or an off-hand remote control may be used to initiate a scrolling mode. In such embodiments, the system may initiate additional processing procedures to identify a control area. If the control object is in the identified control area when the command is received, the match between content movement and control object movement may begin immediately. Otherwise, the system may pause any match of content movement to control object movement after receipt of a scroll initiating command until the control object enters the control area.

Similarly, a scrolling mode may be terminated in the same way with a sound or voice command, or with a button or an off-hand remote control. In such an embodiment, the system may be structured to wait a predetermined amount of time before searching for another gesture or control object in a control area, or may pause to wait for a non-gesture input to initiate the scrolling mode.

In further embodiments, the velocity of a control object may be used to distinguish between not just different modes of a single gesture/command, but also between totally different gestures/commands. Thus, a single motion performed with two different speeds may be interpreted to mean two totally different things. For example, a slow swipe may go to the next song in a song list, while a fast swipe may go to the next album. A slow circle may adjust volume, while a fast circle may turn a device off or may toggle albums or may bring up a home screen or something. In another alternative embodiment, a fast swipe may jump to a different portion of the content, or may jump to an end of the content. In certain embodiments, content may have stops set within the content, and a fast swipe may jump to the next stop setting within the content. In still further embodiments, a gesture or non-gesture command may alternate or select among different gesture combinations for fast and slow scrolling gesture inputs.

FIG. 4 illustrates an embodiment of a system 400 for determining a gesture performed by a person. In various alternative embodiments, system 400 may be implemented among distributed components, or may be implemented in a single device or apparatus such as a cellular telephone with an integrated computer processor with sufficient processing power to implement the modules detailed in FIG. 4. More generally, system 400 may be used for tracking a specific portion of a person or a control object. For instance, system 400 may be used for tracking a person's hands. System 400 may be configured to track one or both hands of a person simultaneously. System 400 may be configured to track an electronic control object and a user's hand simultaneously. Further, system 400 may be configured to track hands of multiple persons simultaneously. While system 400 is described herein as being used to track the location of a person's hands, it should be understood that system 400 may be configured to track other parts of persons, such as heads, shoulders, torsos, legs, etc. The hand tracking of system 400 may be useful for detecting gestures performed by the one or more persons. System 400 itself may not determine a gesture performed by the person or may not perform the actual hand identification or tracking in some embodiments; rather, system 400 may output a position of one or more hands, or may simply output a subset of pixels likely to contain foreground objects. The position of one or more hands may be provided to and/or determined by another piece of hardware or software for gestures, which might be performed by one or more persons. In alternative embodiments, system 400 may be configured to track a control device held in a user's hands or attached to part of a user's body.

System 400 may include image capture module 410, processing module 420, computer-readable storage medium 430, gesture analysis module 440, content control module 450, and display output module 460. Additional components may also be present. For instance, system 400 may be incorporated as part of a computer system, or, more generally, a computerized device. Computer system 600 of FIG. 6 illustrates one potential computer system which may be incorporated with system 400 of FIG. 4. Image capture module 410 may be configured to capture multiple images. Image capture module 410 may be a camera, or, more specifically, a video camera. Image capture module 410 may capture a series of images in the form of video frames. These images may be captured periodically, such as 30 times per second. The images captured by image capture module 410 may include intensity and depth values for each pixel of the images generated by image capture module 410.

Image capture module 410 may project radiation, such as infrared radiation (IR) out into its field-of-view (e.g., onto the scene). The intensity of the returned infrared radiation may be used for determining an intensity value for each pixel of image capture module 410 represented in each captured image. The projected radiation may also be used to determine depth information. As such, image capture module 410 may be configured to capture a three-dimensional image of a scene. Each pixel of the images created by image capture module 410 may have a depth value and an intensity value. In some embodiments, an image capture module may not project radiation, but may instead rely on light (or, more generally, radiation) present in the scene to capture an image. For depth information, the image capture module 410 may be stereoscopic (that is, image capture module 410 may capture two images and combine them into a single image having depth information) or may use other techniques for determining depth.

The images captured by image capture module 410 may be provided to processing module 420. Processing module 420 may be configured to acquire images from image capture module 410. Processing module 420 may analyze some or all of the images acquired from image capture module 410 to determine the location of one or more hands belonging to one or more persons present in one or more of the images. Processing module 420 may include software, firmware, and/or hardware. Processing module 420 may be in communication with computer-readable storage medium 430. Computer-readable storage medium 430 may be used to store information related to background models and/or foreground models created for individual pixels of the images captured by image capture module 410. If the scene captured in images by image capture module 410 is static, it can be expected that a pixel at the same location in the first image and the second image corresponds to the same object. As an example, if a couch is present at a particular pixel in a first image, in the second image, the same particular pixel of the second image may be expected to also correspond to the couch. Background models and/or foreground models may be created for some or all of the pixels of the acquired images. Computer-readable storage medium 430 may also be configured to store additional information used by processing module 420 to determine a position of a hand (or some other part of a person's body). For instance, computer-readable storage medium 430 may contain information on thresholds (which may be used in determining the probability that a pixel is part of a foreground or background model) and/or may contain information used in conducting a principal component analysis.

Processing module 420 may provide an output to another module, such as gesture analysis module 440. Processing module 420 may output two-dimensional coordinates and/or three-dimensional coordinates to another software module, hardware module, or firmware module, such as gesture analysis module 440. The coordinates output by processing module 420 may indicate the location of a detected hand (or some other part of the person's body). If more than one hand is detected (of the same person or of different persons), more than one set of coordinates may be output. Two-dimensional coordinates may be image-based coordinates, wherein an x-coordinate and y-coordinate correspond to pixels present in the image. Three-dimensional coordinates may incorporate depth information. Coordinates may be output by processing module 420 for each image in which at least one hand is located. Further, the processing module 420 may output one or more subsets of pixels having likely background elements extracted and/or likely to include foreground elements for further processing.

Gesture analysis module 440 may be any one of various types of gesture determination systems. Gesture analysis module 440 may be configured to use the two- or three-dimensional coordinates output by processing module 420 to determine a gesture being performed by a person. As such, processing module 420 may output only coordinates of one or more hands, determining an actual gesture and/or what function should be performed in response to the gesture may be performed by gesture analysis module 440. It should be understood that gesture analysis module 440 is illustrated in FIG. 4 for example purposes only. Other possibilities, besides gestures, exist for reasons as to why one or more hands of one or more users may be desired to be tracked. As such, some other module besides gesture analysis module 440 may receive locations of parts of persons' bodies.

Content control module 450 may similarly be implemented as a software module, hardware module, or firmware module. Such a module may be integrated with processing module 420 or structured as a separate remote module in a separate computing device. Content control module 450 may comprise a variety of controls for manipulating content to be output to a display. Such controls may include play, pause, seek, rewind, pan, and zoom, or any other similar such controls. When gesture analysis module 440 identifies an input initiating a scrolling mode, and further identifies synchronized movement along a control plane as part of a scrolling mode, the movement may be communicated to content control module to update a current content position for a content being displayed at a present time.

Display output module 460 may further be implemented as a software module, hardware module, or firmware module. Such a module may include instructions matched to a specific output display that presents content to the user. As the content control module 450 receives gesture commands identified by gesture analysis module 440, the display signal being output to the display by display output module 460 may be modified in real-time or near real-time to adjust the content.

FIGS. 5A and 5B describe one potential embodiment of a head mounted device. In certain embodiments, a head mounted device as described in these figures may further be integrated with a system for providing virtual displays through the head mounted device, where a display is presented in a pair of glasses or other output display the provides the illusion that the display is originating from a passive display surface.

FIG. 5A illustrates components that may be included in embodiments of head mounted devices 10. FIG. 5B illustrates how head mounted devices 10 may operate as part of a system in which a sensor array 500 may provide data to a mobile processor 507 that performs operations of the various embodiments described herein, and communicates data to and receives data from a server 564. It should be noted that the processor 507 head mounted device 10 may include more than one processor (or a multi-core processor) in which a core processor may perform overall control functions while a coprocessor executes applications, sometimes referred to as an application processor. The core processor and applications processor may be configured in the same microchip package, such as a multi-core processor, or in separate chips. Also, the processor 507 may be packaged within the same microchip package with processors associated with other functions, such as wireless communications (i.e., a modem processor), navigation (e.g., a processor within a GPS receiver), and graphics processing (e.g., a graphics processing unit or “GPU”).

The head mounted device 10 may communicate with a communication system or network that may include other computing devices, such as personal computers and mobile devices with access to the Internet. Such personal computers and mobile devices may include an antenna 551, a transmitter/receiver or transceiver 552 and an analog to digital converter 553 coupled to a processor 507 to enable the processor to send and receive data via a wireless communication network. For example, mobile devices, such as cellular telephones, may access the Internet via a wireless communication network (e.g., a Wi-Fi or cellular telephone data communication network). Such wireless communication networks may include a plurality of base stations coupled to a gateway or Internet access server coupled to the Internet. Personal computers may be coupled to the Internet in any conventional manner, such as by wired connections via an Internet gateway (not shown) or by a wireless communication network.

Referring to FIG. 5A, the head mounted device 10 may include a scene sensor 500 and an audio sensor 505 coupled to a control system processor 507 which may be configured with a number of software modules 510-525 and connected to a display 540 and audio output 550. In an embodiment, the processor 507 or scene sensor 500 may apply an anatomical feature recognition algorithm to the images to detect one or more anatomical features. The processor 507 associated with the control system may review the detected anatomical features in order to recognize one or more gestures and process the recognized gestures as an input command. For example, as discussed in more detail below, a user may execute a movement gesture corresponding to a scrolling command using a synchronized motion of two control objects across a control plane. In response to recognizing this example gesture, the processor 507 may initiate a scrolling mode and then adjust content presented in the display as the control objects move to change the current position of the presented content.

The scene sensor 500, which may include stereo cameras, orientation sensors (e.g., accelerometers and an electronic compass) and distance sensors, may provide scene-related data (e.g., images) to a scene manager 510 implemented within the processor 507 which may be configured to interpret three-dimensional scene information. In various embodiments, the scene sensor 500 may include stereo cameras (as described below) and distance sensors, which may include infrared light emitters for illuminating the scene for an infrared camera. For example, in an embodiment illustrated in FIG. 5A, the scene sensor 500 may include a stereo red green-blue (RGB) camera 503A for gathering stereo images, and an infrared camera 503B configured to image the scene in infrared light which may be provided by a structured infrared light emitter 503C. The structured infrared light emitter may be configured to emit pulses of infrared light that may be imaged by the infrared camera 503B, with the time of received pixels being recorded and used to determine distances to image elements using time-of-flight calculations. Collectively, the stereo RGB camera 503A, the infrared camera 503B and the infrared emitter 503C may be referred to as an RGB-D (D for distance) camera 503.

The scene manager module 510 may scan the distance measurements and images provided by the scene sensor 500 in order to produce a three-dimensional reconstruction of the objects within the image, including distance from the stereo cameras and surface orientation information. In an embodiment, the scene sensor 500, and more particularly an RGB-D camera 503, may point in a direction aligned with the field of view of the user and the head mounted device 10. The scene sensor 500 may provide a full body three-dimensional motion capture and gesture recognition. The scene sensor 500 may have an infrared light emitter 503C combined with an infrared camera 503C, such as a monochrome CMOS sensor. The scene sensor 500 may further include stereo cameras 503A that capture three-dimensional video data. The scene sensor 500 may work in ambient light, sunlight or total darkness and may include an RGB-D camera as described herein. The scene sensor 500 may include a near-infrared (NIR) pulse illumination component, as well as an image sensor with a fast gating mechanism. Pulse signals may be collected for each pixel and correspond to locations from which the pulse was reflected and can be used to calculate the distance to a corresponding point on the captured subject.

In another embodiment, the scene sensor 500 may use other distance measuring technologies (i.e., different types of distance sensors) to capture the distance of the objects within the image, for example, ultrasound echo-location, radar, triangulation of stereoscopic images, etc. The scene sensor 500 may include a ranging camera, a flash LIDAR camera, a time-of-flight (ToF) camera, and/or a RGB-D camera 503, which may determine distances to objects using at least one of range-gated ToF sensing, RF-modulated ToF sensing, pulsed-light ToF sensing, and projected-light stereo sensing. In another embodiment, the scene sensor 500 may use a stereo camera 503A to capture stereo images of a scene, and determine distance based on a brightness of the captured pixels contained within the image. As mentioned above, for consistency any one or all of these types of distance measuring sensors and techniques are referred to herein generally as “distance sensors.” Multiple scene sensors of differing capabilities and resolution may be present to aid in the mapping of the physical environment, and accurate tracking of the user's position within the environment.

In an additional further embodiment, a scene sensor may comprise an accelerometer and/or gyroscope of an electronic device such as a cellular telephone. Remote detection of the device may comprise wireless communication with the device to receive accelerometer and gyroscope data that indicates movement of the phone. This movement may be associated with the display surface by an input or selection of the user or system, which sets a starting location and an orientation matched to a current content position, and then adjusts the current content position in response to movement and orientation changes identified by accelerometer and gyroscope measurements.

The head mounted device 10 may also include an audio sensor 505 such as a microphone or microphone array. An audio sensor 505 enables the head mounted device 10 to record audio, and conduct acoustic source localization and ambient noise suppression. The audio sensor 505 may capture audio and convert the audio signals to audio digital data. A processor associated with the control system may review the audio digital data and apply a speech recognition algorithm to convert the data to searchable text data. The processor may also review the generated text data for certain recognized commands or keywords and use recognized commands or keywords as input commands to execute one or more tasks. For example, a user may speak a command such as “initiate scrolling mode” have the system search for control objects along an expected control plane. As another example, the user may speak “close content” to close a file displaying content on the display.

The head mounted device 10 may also include a display 540. The display 540 may display images obtained by the camera within the scene sensor 500 or generated by a processor within or coupled to the head mounted device 10. In an embodiment, the display 540 may be a micro display. The display 540 may be a fully occluded display. In another embodiment, the display 540 may be a semitransparent display that can display images on a screen that the user can see through to view the surrounding room. The display 540 may be configured in a monocular or stereo (i.e., binocular) configuration. Alternatively, the head-mounted device 10 may be a helmet mounted display device, worn on the head, or as part of a helmet, which may have a small display 540 optic in front of one eye (monocular) or in front of both eyes (i.e., a binocular or stereo display). Alternatively, the head mounted device 10 may also include two display units 540 that are miniaturized and may be any one or more of cathode ray tube (CRT) displays, liquid crystal displays (LCDs), liquid crystal on silicon (LCos) displays, organic light emitting diode (OLED) displays, Mirasol displays based on Interferometric Modulator (IMOD) elements which are simple micro-electro-mechanical system (MEMS) devices, light guide displays and wave guide displays, and other display technologies that exist and that may be developed. In another embodiment, the display 540 may comprise multiple micro-displays 540 to increase total overall resolution and increase a field of view.

The head mounted device 10 may also include an audio output device 550, which may be a headphone and/or speaker collectively shown as reference numeral 550 to output audio. The head mounted device 10 may also include one or more processors that can provide control functions to the head mounted device 10 as well as generate images, such as of virtual objects. For example, the device 10 may include a core processor, an applications processor, a graphics processor and a navigation processor. Alternatively, the head mounted display 10 may be coupled to a separate processor, such as the processor in a smartphone or other mobile computing device. Video/audio output may be processed by the processor or by a mobile CPU, which is connected (via a wire or a wireless network) to the head mounted device 10. The head mounted device 10 may also include a scene manager block 510, a user control block 515, a surface manager block 520, an audio manager block 525 and an information access block 530, which may be separate circuit modules or implemented within the processor as software modules. The head mounted device 10 may further include a local memory and a wireless or wired interface for communicating with other devices or a local wireless or wired network in order to receive digital data from a remote memory 555. Using a remote memory 555 in the system may enable the head mounted device 10 to be made more lightweight by reducing memory chips and circuit boards in the device.

The scene manager block 510 of the controller may receive data from the scene sensor 500 and construct the virtual representation of the physical environment. For example, a laser may be used to emit laser light that is reflected from objects in a room and captured in a camera, with the round trip time of the light used to calculate distances to various objects and surfaces in the room. Such distance measurements may be used to determine the location, size and shape of objects in the room and to generate a map of the scene. Once a map is formulated, the scene manager block 510 may link the map to other generated maps to form a larger map of a predetermined area. In an embodiment, the scene and distance data may be transmitted to a server or other computing device which may generate an amalgamated or integrated map based on the image, distance and map data received from a number of head mounted devices (and over time as the user moved about within the scene). Such an integrated map data made available via wireless data links to the head mounted device processors.

The other maps may be maps scanned by the instant device or by other head mounted devices, or may be received from a cloud service. The scene manager 510 may identify surfaces and track the current position of the user based on data from the scene sensors 500. The user control block 515 may gather user control inputs to the system, for example audio commands, gestures, and input devices (e.g., keyboard, mouse). In an embodiment, the user control block 515 may include or be configured to access a gesture dictionary to interpret user body part movements identified by the scene manager 510, As discussed above a gesture dictionary may store movement data or patterns for recognizing gestures that may include pokes, pats, taps, pushes, guiding, flicks, turning, rotating, grabbing and pulling, two hands with palms open for scrolling images, drawing (e.g., finger painting), forming shapes with fingers, and swipes, all of which may be accomplished on or in close proximity to the apparent location of a virtual object in a generated display. The user control block 515 may also recognize compound commands. This may include two or more commands. For example, a gesture and a sound (e.g. clapping) or a voice control command (e.g. ‘OK’ detected hand gesture made and combined with a voice command or a spoken word to confirm an operation). When a user control 515 is identified the controller may provide a request to another subcomponent of the device 10.

The head mounted device 10 may also include a surface manager block 520. The surface manager block 520 may continuously track the positions of surfaces within the scene based on captured images (as managed by the scene manager block 510) and measurements from distance sensors. The surface manager block 520 may also continuously update positions of the virtual objects that are anchored on surfaces within the captured image. The surface manager block 520 may be responsible for active surfaces and windows. The audio manager block 525 may provide control instructions for audio input and audio output. The audio manager block 525 may construct an audio stream delivered to the headphones and speakers 550.

The information access block 530 may provide control instructions to mediate access to the digital information. Data may be stored on a local memory storage medium on the head mounted device 10. Data may also be stored on a remote data storage medium 555 on accessible digital devices, or data may be stored on a distributed cloud storage memory, which is accessible by the head mounted device 10. The information access block 530 communicates with a data store 555, which may be a memory, a disk, a remote memory, a cloud computing resource, or an integrated memory 555.

FIG. 6 illustrates an example of a computing system in which one or more embodiments may be implemented. A computer system as illustrated in FIG. 6 may be incorporated as part of the previously described computerized devices in FIGS. 4 and 5. Any component of a system according to various embodiments may include a computer system as described by FIG. 6, including various camera, display, HMD, and processing devices FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like). Such processors may function as elements of processing module 420 or mobile CPU 507, or of any device described herein, including HMD 10, mobile device 8, display 14, cameras 18 or 218 or any other such device which may be used in a gesture detection system. The hardware elements may additionally include one or more input devices 615, which can include without limitation a mouse, a keyboard and/or the like. In certain embodiment, detection devices may be considered input devices 615. Thus input devices 615 may comprise accelerometers, infrared or other electromagnetic radiation sensors, acoustic or ultrasound sensors, or any other such method of detecting movement. Hardware elements may additionally comprise one or more output devices 620, which can include without limitation a display device such as HMD 10, display 14, or display 214. Output devices 620 may additionally comprise a printer, a speaker, or any other such transceiver. The bus 605 may couple two or more of the processors 610, or multiple cores of a single processor or a plurality of processors.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or similar communication interfaces. The communications subsystem 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processor(s) 610.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
engaging, in response to a scroll initiating input from a user, a scrolling process;
detecting, based on information from one or more remote detection devices, a speed of a control object associated with the user during the scrolling process; and
executing at a computerized device one of a plurality of scroll modes during the scrolling process based on the detected speed.

2. The method of claim 1, wherein the executing comprises:
matching, as part of the scrolling process, a first content movement on a display to a first scrolling movement of the control object when the speed of the control object during the first scrolling movement of the control object is below a speed threshold; and
engaging a free scrolling mode when the speed of the control object is above the speed threshold as part of a second scrolling movement of the control object.

3. The method of claim 2, wherein the control object comprises a fingertip of the user, and wherein engaging the free scrolling mode when the speed of the control object is above the speed threshold comprises:
detecting a flicking motion of the fingertip where the speed of the fingertip exceeds the speed threshold while a speed of a hand associated with the fingertip does not exceed the speed threshold.

4. The method of claim 2 wherein the scrolling process comprises pausing matching the first content movement to the first scrolling movement of the control object when the control object moves away from a plane parallel to a display surface of the display at a first area and resuming matching the first content movement to the first scrolling movement of the control object when the control object reenters the plane parallel to the display at a second area.

5. The method of claim 4 wherein the scroll initiating input from the user comprises detecting that the control object is held in a predetermined pose for a threshold amount of time.

6. The method of claim 5 wherein detecting that the control object is held in the predetermined pose comprises detecting that the control object remains within a cubic area for the threshold amount of time.

7. The method of claim 5 wherein detecting that the control object is held in the predetermined pose for the threshold amount of time comprises:
measuring, using the one or more remote detection devices, a z-axis distance from the display surface to the control object, wherein the plane parallel to the display surface is at the z-axis distance from the display surface plus or minus an error tolerance distance in a z-axis direction; and
identifying the plane parallel to the display surface based on the z-axis distance from the display surface to the control object.

8. The method of claim 4 wherein a user selection of a scrolling mode from one of the plurality of scroll modes is made while the control object is in the plane parallel to the display surface.

9. The method of claim 4 further comprising:
setting a content scroll speed to a maximum scroll speed in response to the second scrolling movement of the control object; and
decelerating the content scroll speed at a predetermined rate.

10. The method of claim 9 further comprising detecting a poking motion normal to the plane parallel to the display surface of the display; and
setting the content scroll speed to zero in response to the poking motion.

11. The method of claim 1 wherein detecting the speed of the control object comprises detecting a control object acceleration between a first frame and a second frame; and
rejecting the speed of the control object associated with the first frame and the second frame as a jitter error if the control object acceleration is above a predetermined acceleration threshold.

12. The method of claim 1 wherein detecting the speed of the control object comprises detecting an average speed of the control object over at least a minimum allowable free scrolling distance.

13. The method of claim 1
wherein detecting the speed of the control object comprises receiving accelerometer data from a device held by the user.

14. The method of claim 1 wherein the scrolling process comprises a sideways motion of content in a display.

15. The method of claim 1 wherein the executing comprises causing content to scroll according to the one of the plurality of scroll modes at a display of a head mounted display, wherein content scrolls on a virtual display surface projected onto an eye of the user by the head mounted display.

16. A system comprising:
a first camera;
a first computing device communicatively coupled to the first camera; and
an output display communicatively coupled to the first computing device and communicatively coupled to the first camera;
wherein the first computing device comprises a gesture analysis module configured to:
engage, in response to a scroll initiating input from a user, a scrolling process;
detect, based on information from one or more remote detection devices, a speed of a control object associated with the user during the scrolling process; and
execute at a computerized device one of a plurality of scroll modes during the scrolling process based on the detected speed.

17. The system of claim 16 wherein the gesture analysis module is further configured to match, as part of a first scroll mode of the plurality of scroll modes, a first content movement in a display on a display surface to a first scrolling movement of the control object when the speed of the control object during the first scrolling movement of the control object is below a speed threshold.

18. The system of claim 17 wherein the first scroll mode comprises pausing matching the first content movement to the first scrolling movement of the control object when the control object moves away from a plane parallel to the display surface at a first area and resuming matching the first content movement to the first scrolling movement of the control object when the control object reenters the plane parallel to the display at a second area.

19. The system of claim 17 wherein the gesture analysis module engages a free scrolling mode as a second scroll mode of the plurality of scroll modes when the speed of the control object is above the speed threshold.

20. The system of claim 17 further comprising:
a second camera communicatively coupled to the first computing device and the output display;
wherein the gesture analysis module identifies an obstruction between the first camera and the control object and detects the first scrolling movement of the control object using a second image from the second camera.

21. The system of claim 17 wherein the gesture analysis module is further configured to engage a free scrolling mode when the speed of the control object is above the speed threshold as part of a second scrolling movement of the control object.

22. The system of claim 21 wherein the gesture analysis module is further configured to:
set a content scroll speed to a maximum scroll speed in response to the second scrolling movement of the control object; and
decelerate the content scroll speed at a predetermined rate.

23. The system of claim 22 wherein the gesture analysis module is further configured to detect a stop hand signal in a plane parallel to the display surface of the display; and
set the content scroll speed to zero in response to the stop hand signal.

24. The system of claim 22 wherein the gesture analysis module is further configured to detect a pointing gesture in a plane parallel to the display surface of the display;
set the content scroll speed to zero in response to the pointing gesture; and
match a second content movement to a second scrolling movement of the control object following detection of the pointing gesture.

25. The system of claim 16 wherein the scroll initiating input from the user comprises the control object being held in a predetermined pose for a threshold amount of time.

26. The system of claim 25 wherein the gesture analysis module is further configured to detect that the control object is being held in the predetermined pose for the threshold amount of time by:
measuring, using the one or more remote detection devices, a z-axis distance from a display surface to the control object, wherein a plane parallel to the display surface is at the z-axis distance from the display surface plus or minus an error tolerance distance in a z-axis direction; and
identifying the plane parallel to the display surface based on the z-axis distance from the display surface to the control object.

27. The system of claim 16 wherein the gesture analysis module is configured to detect the speed of the control object by detecting a control object acceleration between a first frame and a second frame; and
rejecting the speed of the control object associated with the first frame and the second frame as a jitter error if the control object acceleration is above a predetermined acceleration threshold.

28. The system of claim 16 wherein the scrolling process comprises a diagonal motion of content in a display.

29. A device comprising:
means for engaging, in response to a scroll initiating input from a user, a scrolling process;
means for detecting, based on information from one or more remote detection devices, a speed of a control object associated with the user during the scrolling process; and
means for executing at a computerized device one of a plurality of scroll modes during the scrolling process based on the detected speed.

30. The device of claim 29, wherein the executing comprises:
means for matching, as part of the scrolling process, a first content movement on a display to a first scrolling movement of the control object when the speed of the control object during the first scrolling movement of the control object is below a speed threshold; and
means for engaging a free scrolling mode when the speed of the control object is above the speed threshold as part of a second scrolling movement of the control object.

31. The device of claim 30 further comprising:
means for matching the first content movement to the first scrolling movement of the control object when the control object moves away from a plane parallel to a surface of the display at a first area and resuming matching the first content movement to the first scrolling movement of the control object when the control object reenters the plane parallel to the display at a second area;
means for measuring a z-axis distance from the display surface to the control object, wherein the plane parallel to the display surface is at the z-axis distance from the display surface plus or minus an error tolerance distance in a z-axis direction; and
means for identifying the plane parallel to the display surface based on the z-axis distance from the display surface to the control object.

32. A non-transitory computer readable medium comprising computer readable instructions that when executed by a processor, cause a device to:
engage, in response to a scroll initiating input from a user, a scrolling process;
detect, based on information from one or more remote detection devices, a speed of a control object associated with the user during the scrolling process; and
execute at a computerized device one of a plurality of scroll modes during the scrolling process based on the detected speed.
